(19) United States
(12) Patent Application Publication
(10) Pub. No.: US 2013/0063235 A1
(43) Pub. Date: Mar. 14, 2013

(54) ELECTRO-MAGNETIC DEVICE HAVING A POLYMER HOUSING

(71) Applicants: John Horowy, Rockford, IL (US); Mark Hamilton Severson, Rockford, IL (US); Debabrata Pal, Hoffman Estates, IL (US)

(72) Inventors: John Horowy, Rockford, IL (US); Mark Hamilton Severson, Rockford, IL (US); Debabrata Pal, Hoffman Estates, IL (US)

(73) Assignee: HAMILTON SUNDSTRAND CORPORATION, Windsor Locks, CT (US)

(21) Appl. No.: 13/230,284

(22) Filed: Sep. 12, 2011

(51) Int. Cl. H01F 27/18; H01F 27/02

(52) U.S. Cl. 336/61; 336/90

(57) ABSTRACT

An electro-magnetic device includes a core having a first end that extends to a second end through an outer core surface and an inner core surface. A plurality of windings extend about the core, and a polymer housing covers the core and the plurality of windings. The polymer housing includes an outer housing member that extends adjacent to the outer core surface and an inner housing member that extends adjacent to the inner core surface.

### BACKGROUND OF THE INVENTION

Exemplary embodiments pertain to the art of electro-magnetic devices and, more particularly, to an electro-magnetic device having a polymer housing.

In operation, large electro-magnetic assemblies produce a significant amount of heat. The heat must be dissipated in order to prevent damage to internal components, such as insulation and the like, that cannot tolerate prolonged exposure to increased temperature levels. As such, large electro-magnetic assemblies such as autotransformer rectifier units, inductors and the like are generally cooled through conduction cooling techniques. To that end, many large electro-magnetic assemblies are arranged in a housing formed from aluminum or other thermally conductive metal and surrounded by a potting compound. The potting compound enhances conduction heat transfer between the electro-magnetic assembly and the housing. In addition to the potting compound, many electro-magnetic assemblies employ thermal gap pads or other devices to further enhance thermal conductivity.

### BRIEF DESCRIPTION OF THE INVENTION

Disclosed is an electro-magnetic device including a core having a first end that extends to a second end through an outer core surface and an inner core surface. A plurality of windings extend about the core, and a polymer housing covers the core and the plurality of windings. The polymer housing includes an outer housing member that extends adjacent to the outer core surface and an inner housing member that extends adjacent to the inner core surface.

Also disclosed is an electro-magnetic device including a core member, a plurality of windings extending about the core member, and a polymer housing encapsulating the core member and the plurality of windings.

### BRIEF DESCRIPTION OF THE DRAWINGS

The following descriptions should not be considered limiting in any way. With reference to the accompanying drawings, like elements are numbered alike:

FIG. 1 is a cross-sectional view of an electro magnetic device including a polymer housing in accordance with an exemplary embodiment;

FIG. 2 is a partial cross-sectional view of the electo-magtnetic device of FIG. 1;

FIG. 3 is a perspective view of an electro-magnetic device having a polymer housing provided with heat pipes in accordance with another aspect of the exemplary embodiment;

FIG. 4 is a partial cross-sectional view of the polymer housing of FIG. 3; and

FIG. 5 is a plan view of a polymer housing in accordance with another aspect of the exemplary embodiment.

### DETAILED DESCRIPTION OF THE INVENTION

A detailed description of one or more embodiments of the disclosed apparatus is presented herein by way of exemplification and not limitation with reference to the Figures.

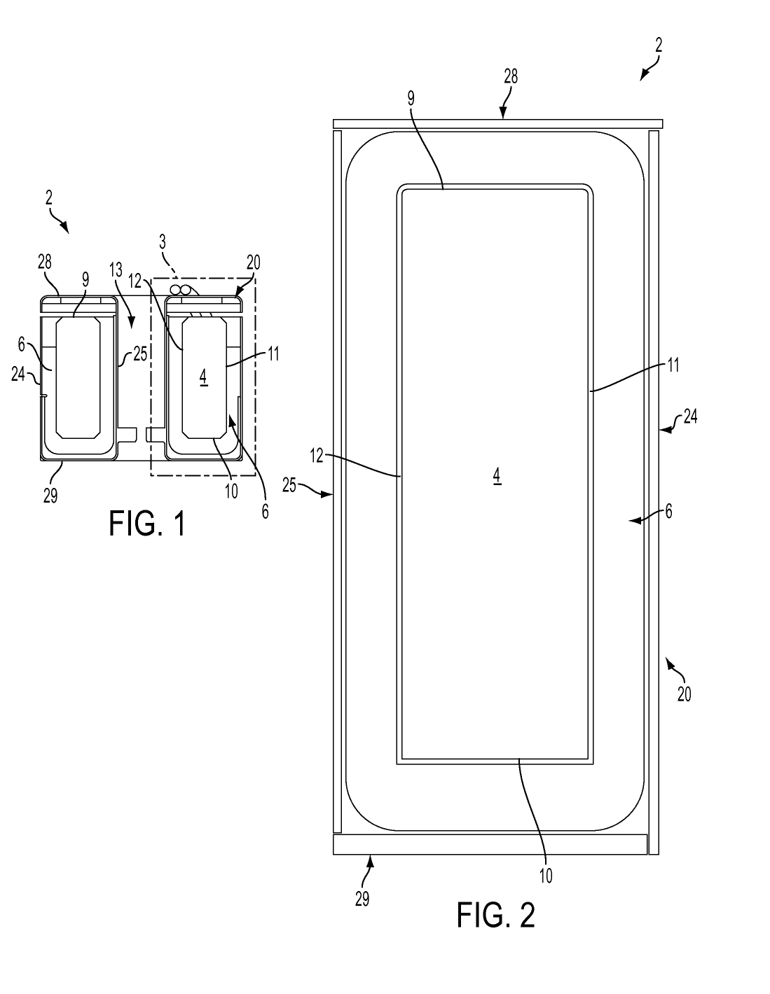

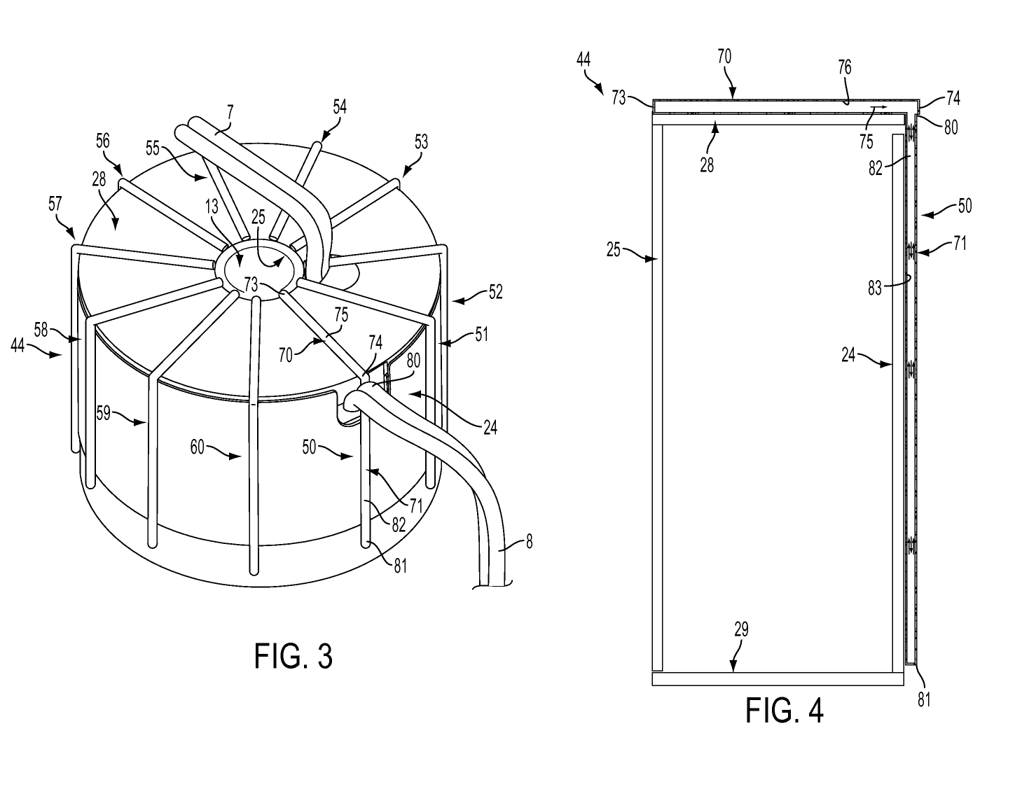

As shown in FIGS. 1 and 2 an electro-magnetic device in accordance with an exemplary embodiment is indicated generally at 2. It shall be understood that FIG. 2 is more detailed depiction of the portion of the FIG. 1 surrounded by dashed box 3. Electro-magnetic device 2 includes a toroidal core 4 surrounded by a plurality of windings 6. It shall be understood that the plurality of windings 6 could be formed by a single wire or other electrical conductor repeatedly wrapped around the toroidal core. Toroidal core 4 includes a first end 9 and extends to a second end 10. The first and second ends 9, 10 are connected by an outer core or winding surface 11 and an inner core or winding surface 12 such that a hollow core 13 is defined between the ends. The plurality of windings 6 are wrapped around toroidal core 4 so as to contact or are proximate to the outer and inner winding surfaces 11 and 12 and pass through hollow core 13 over first and second ends 9 and 10. The plurality of windings 6 include a first end 7 and a second end 8 (FIG. 3). In the exemplary embodiment shown, electro-magnetic device 2 takes the form of an inductor. Electro-magnetic device 2 is housed within a polymer housing 20. Polymer housing 20 is formed from a thermally conductive polymer that is configured to dissipate heat developed at electro-magnetic device 2 generated by a current passing through plurality of windings 6. More specifically, polymer housing 20 is formed from a material having a thermal conductivity of about 10-20 watts/m K. In accordance with one aspect of the exemplary embodiment, polymer housing 20 is formed from CoolPoly® material produced by Cool Polymers, Inc. However, it should be understood that other polymers or electrically insulative materials having generally similar thermal conductivity properties could also be employed.

In accordance with the exemplary embodiment, polymer housing 20 includes an outer housing member 24 that is configured to cover outer winding surface 11. Polymer housing 20 also includes an inner housing member 25 that is configured to cover inner winding surface 12. Polymer housing 20 further includes a first end wall 28 and a second end wall 29 that connect outer housing member 24 with inner housing member 25. When toroidal core 4 is installed within polymer housing 20, plurality of windings 6 contact internal surfaces (not separately labeled) of second side wall 29, outer housing member 24, and inner housing member 25. The plurality of windings 6 could also be in contact with an inner surface (also not separately labeled) of first end wall 28.

Reference will now be made to FIGS. 3 and 4, wherein like reference numbers represent corresponding parts in the respective views, in describing a polymer housing 44 in accordance with another aspect of the exemplary embodiment. Polymer housing 44 is provided with a plurality of heat pipes 50, 51, 52, 53, 54, 55, 56, 57, 58, 59, 60 that extend over outer housing member 24 and first end wall 28. A detailed description will follow with reference to heat pipe 50 with an understanding that any of heat pipes 51-60 may include similar structure. Heat pipe 50 includes a first heat pipe member 70 that extends across first end wall 28 and a second heat pipe member 71 that extends over outer housing member 24. First heat pipe member 70 includes a first end portion 73 that extends to a second end portion 74 through a conduit section 75. Conduit section 75 includes an internal surface (not separately labeled) provided with a wicking material 76. As will be described more fully below, wicking material 76 provides a surface feature that facilitates transfer of a heat conducting fluid (not shown) contained within heat pipe 50. Similarly, second heat pipe member 71 includes a first end portion 80 that is fluidly connected with second end portion 74 of first heat pipe member 70. First end portion 80 extends to a second end portion 81 through a conduit section 82. Conduit section 82 includes internal surfaces (not separately labeled) provided with a wicking material 83. With this arrangement, first end portion 73 of first heat pipe member 70 and second end portion 81 of second heat pipe member 71 are sealed so as to contain a predetermined volume of the heat conducting fluid.

Heat pipes 50-60 enhance thermal conduction of heat away from polymer housing 20. More specifically, heat conducting fluid within each heat pipe 50-60 absorbs heat from polymer housing 20. After absorbing heat, the heat conducting fluid vaporizes and flows within each heat pipe 50-60 and flows toward second end portion 81 of second heat pipe member 71. The heat conducting fluid cools and returns to a liquid state. The liquid travels upward toward first end portion 73 of first heat pipe member 70 aided by wicking materials 76 and 83. As such, heat pipes 50-60 should be understood to be closed fluid systems that facilitate heat transfer from polymer housing 44 without requiring an external fluid source. Of course, it should be understood that replenishment of the heat conducting fluid may be required from time to time.

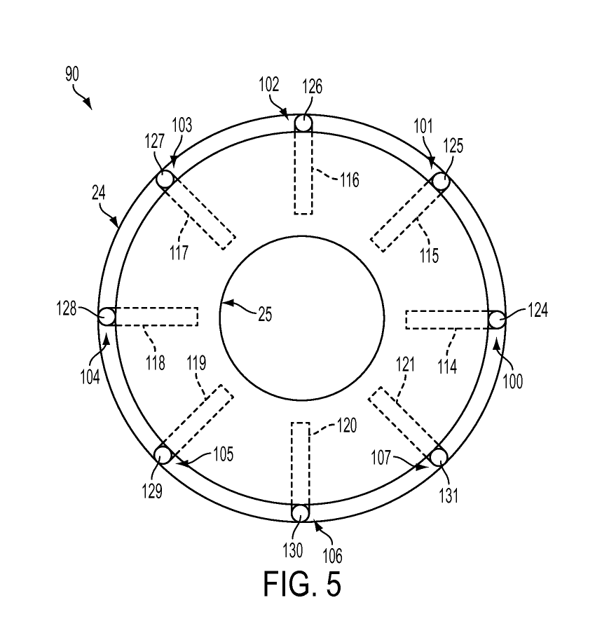

Reference will now follow to FIG. 5, wherein like reference numbers represent corresponding parts in the respective views in describing a polymer housing 90 in accordance with yet another aspect of the exemplary embodiment. Polymer housing 90 includes a plurality of heat pipes 100, 101, 102, 103, 104, 105, 106, 107 extending within outer housing member 24 and first end wall 28. More specifically, heat pipes 100-107 include corresponding first heat pipe members 114, 115, 116, 117, 118, 119, 120, 121 that extend within first end wall 28. First heat pipe members 114-121 are fluidly connected to corresponding ones of second heat pipe members 124, 125, 126, 127, 128, 129, 130, 131 that extend within outer housing member 24. Heat pipes 100-107 may constitute distinct members that are inserted into passages formed internally to first end wall 28 and outer housing member 24. Heat pipes 100-107 may alternatively constitute molded features provided with a wicking material formed internally to first end wall 28 and outer housing member 24.

At this point it should be understood that the exemplary embodiments describe an electro-magnetic device having a non-metallic or polymer housing that possess heat transfer properties sufficient to conduct high heat loads away from internal components such as the core and windings. In addition other aspects of the exemplary embodiment describe heat pipes mounted to externals surfaces of the polymer housing to enhance heat transfer. At this point it should be understood that while described in terms of housing an inductor, the polymer housing 20, 90 may be used in connection with a wide variety of electro-magnetic devices, such as an autotransformer rectifier unit. The electrically insulating polymer housing 20, 90 enables intimate contact with conductive components, such as windings 6 of FIGS. 1 and 2. The polymer housing 20, 90 may eliminate a need for a thermal gap pad which allows for a smaller housing size. Polymer housing material can have a lower density than metallic housing material, which further reduces housing weight.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

1. An electro-magnetic device comprising:
a core having a first end that extends to a second end through an outer core surface and an inner core surface;
a plurality of windings that extend about the core; and
a polymer housing covering the core and the plurality of windings, the polymer housing including an outer housing member that extends adjacent to the outer core surface and an inner housing member that extends adjacent to the inner core surface, the polymer housing including one or more heat pipes that are provided on the outer housing member.

2. The electro-magnetic device according to claim 1, wherein the polymer housing is in direct contact with a portion of the plurality of windings.

3. The electro-magnetic device according to claim 1, wherein the polymer housing includes a first end wall extending between the inner housing member and the outer housing member adjacent the first end of the core and a second end wall extending between the inner housing member and the outer housing member adjacent the second end of the core.

4. The electro-magnetic device according to claim 3, wherein a portion of the plurality of windings directly contacts the second end wall.

5. (canceled)

6. The electro-magnetic device according to claim 3, wherein the one or more heat pipes extend along an outer surface of the outer wall member and the first end wall.

7. The electro-magnetic device according to claim 3, wherein the one or more heat pipes extend within the first end wall and the outer housing member.

8. The electro-magnetic device according to claim 3, wherein the one or more heat pipes are integrally formed in the first end wall and outer wall member.

9. The electro-magnetic device according to claim 3, where the one or more heat pipes includes a first end portion that extends to a second end portion through a conduit section, each of the first and second end portions being sealed with the conduit section including a predetermined volume of fluid.

10. The electro-magnetic device according to claim 9, wherein the conduit portion includes a wicking material.

11. An electro-magnetic device comprising:
a core member;
a plurality of windings extending about the core member;
a polymer housing encapsulating the core member and the plurality of windings; and
one or more heat pipes in thermally conductive contact with the polymer housing.

12. The electro-magnetic device according to claim 11, wherein the polymer housing is in direct contact with a portion of the plurality of windings.

13. The electro-magnetic device according to claim 12, wherein the polymer housing includes a first end wall, a second end wall and one or more side walls extending between the first and second end walls.

14. (canceled)

15. The electro-magnetic device according to claim 13, wherein the one or more heat pipes extend along the outer wall member and the first end wall.

16. The electro-magnetic device according to claim 13, wherein the one or more heat pipes extend through the housing within the first end wall and the one or more side walls.

17. The electro-magnetic device according to claim 16, wherein the one or more heat pipes are integrally formed in the first end wall and one or more side walls.

18. The electro-magnetic device according to claim 11, wherein the electro-magnetic device is one of an autotransformer rectifier unit and an inductor.

19. The electro-magnetic device according to claim 13, where the one or more heat pipes includes a first end portion that extends to a second end portion through a conduit section, each of the first and second end portions being sealed with the conduit section including a predetermined volume of fluid.

20. The electro-magnetic device according to claim 13, wherein the conduit portion includes a wicking material.
